(19) United States
(12) Patent Application Publication
(10) Pub. No.: US 2012/0054394 A1
(43) Pub. Date: Mar. 1, 2012

(54) Fast Biased Locks

(75) Inventors: Kedar S. Namjoshi, Basking Ridge, NJ (US); Nalini Vasudevan, New York, NY (US)

(73) Assignee: ALCATEL-LUCENT USA INC., Murray Hill, NJ (US)

(21) Appl. No.: 12/873,766

(22) Filed: Sep. 1, 2010

(51) Int. Cl. G06F 17/00; G06F 12/00

(52) U.S. Cl. 710/200

(57) ABSTRACT

Access by multiple threads to a common resource can be controlled using a bias-lock having a single owner thread selected from among the plurality of threads. The bias-lock includes an n-process lock for which non-owner processes compete and a 2-process lock for which the owner and non-owner holder of the n-process lock compete. The owner of the bias-lock can be switched to one of the non-owner threads without suspending the owner thread. An asymmetric lock can be used to eliminate the need for the 2-process lock. Bias-locks can further be extended to provide read/write bias locking mechanisms.

### FIELD OF THE INVENTION

The present invention is generally directed to control of access to shared resources in a computing environment, and more particularly to access control mechanisms that are optimized for use in computing environments having a single dominant process.

### BACKGROUND

Locks, such as semaphores and mutexes, are typically used to ensure exclusive access to shared memory locations, and can be used to control access to other shared resources such as hardware access and various abstractions of memory and hardware. While using locks correctly is often the biggest challenge, lock operations are expensive. Executing an atomic instruction is costly because most processors implement it by locking the memory bus to prevent other processors from executing memory operations. The cost when there is contention among multiple processors can be substantially higher, especially if a cache miss is involved. This overhead can be prohibitive for a performance-critical application such as packet processing, which may have to keep up with line rates of over 1 Gbps and thus has a very limited cycle budget for actual processing. Reducing locking overhead, therefore, can be very useful. Therefore, programmers are also concerned with their efficiency.

Accordingly, improvements in the performance of locking mechanisms that control access to shared resources are desirable.

### SUMMARY OF THE INVENTION

In accordance with an embodiment of the present invention, access by a plurality of threads to a common resource can be controlled using a bias-lock having a single owner thread selected from among the plurality of threads. The bias-lock includes a first sub-lock, and a second sub-lock. When a request is received to lock the bias-lock, the owner of the bias-lock is tested. In response to determining that the first thread is the bias-lock owner, the first sub-lock is locked. In response to determining the first thread is not the bias-lock owner, the second sub-lock is locked and the first sub-lock is locked after successfully locking the second sub-lock

In accordance with a further aspect of the present invention, when a request is received to unlock the bias-lock, the bias-lock owner is tested. If the thread requesting to unlock the bias-lock is the owner, the first sub-lock is unlocked. If the thread requesting to unlock the bias-lock is not the owner, the first sub-lock is unlocked and the second sub-lock is unlocked after successfully unlocking the first sub-lock.

In yet a further feature of the present invention, the owner of the bias-lock can be switched to one of the non-owner threads. When a request to switch the owner is received, the second sub-lock is locked and the first sub-lock is locked after successfully locking the second sub-lock. The bias-lock owner is then switched to the thread requesting the switch. The first sub-lock is then unlocked and the second sub-lock is unlocked after ensuring the previous lock owner is not requesting to lock the bias-lock.

In accordance with a further embodiment of the present invention, access by a plurality of threads to a common resource can be controlled using an asymmetric bias-lock having a sub-lock and a single owner configured to grant the bias-lock to non-owner threads. In response to receiving a request to lock the bias-lock from a thread to lock, the owner of the bias-lock is tested. In response to determining the calling thread is the bias-lock owner, it is ensured the bias-lock is not granted to a non-owner thread. In response to determining the calling thread is not the bias-lock owner, the sub-lock is locked, the bias-lock is identified as requested by the non-owner-thread, and it is ensured the bias-lock owner has granted the bias-lock to the non-owner thread.

In yet a further aspect of the asymmetric bias-lock of the present invention, in response to receiving a request to unlock the bias-lock, the bias-lock owner is tested. If the calling thread is the bias-lock owner, it is tested whether the bias-lock is identified as requested by the non-owner-thread. If the bias-lock is identified as requested by the non-owner-thread, the identification is removed, consistency of the common resource is ensured, and the bias-lock is identified as locked by a non-owner thread. In response to determining the first thread is not the bias-lock owner, consistency of the common resource is ensured, the identification of the bias-lock as locked by the non-owner thread is removed, and the sub-lock is unlocked.

In yet a further embodiment of the present invention, a read-write bias-lock having a single owner, a first sub-lock, and a second sub-lock can be used to control access to a common resource. When a read-lock request is received from a calling thread the bias-lock owner is tested. In response to determining the calling thread is the bias-lock owner, the bias-lock is identified as locked for reading by the owner and it is ensured that a non-owner thread has not acquired a write-lock of the bias-lock. In response to determining the calling thread is not the bias-lock owner, a read-lock is obtained on the second sub-lock and the first sub-lock is locked. The number of threads having a read-lock of the bias-lock is tested, and in response to determining one non-owner thread has the read-lock of the bias-lock, the bias-lock is identified as having a non-owner-thread-read-lock and it is ensured that the owner has not obtained an owner-thread-write-lock.

In accordance with a further aspect of the read-write bias-lock of the present invention, in response to receiving a write-lock request from a calling thread, the bias-lock owner is tested. In response to determining the calling thread is the bias-lock owner, the bias-lock is identified as having an owner-thread-write-lock, and it is ensured that the bias-lock is not identified as having a non-owner-thread-write-lock and is not identified as having the non-owner-thread-read-lock. In response to determining the calling thread is not the bias-lock owner, a write-lock of the second sub-lock is obtained and the bias-lock is identified as having the non-owner-thread-write-lock. It is then ensured that the bias-lock is not identified as having the owner-thread-write-lock and is not identified as having the owner-thread-read-lock.

In accordance with yet a further aspect of the read-write bias-lock of the present invention, in response to receiving a read-unlock request from a calling thread, the bias-lock owner is tested. If the calling thread is the bias-lock owner, the bias-lock is identified as not having an owner-thread-read-lock and not having an owner-thread-write-lock. If the calling thread is not the bias-lock owner, the first sub-lock is locked, the bias-lock is identified as not having an non-owner-thread-read-lock and as not having an non-owner-thread-write-lock, and in response to determining no non-owner-thread have requested a read-lock of the bias-lock, the first sub-lock is unlocked and the second sub-lock is unlocked.

In accordance with yet a further aspect of the read-write bias-lock of the present invention, in response to receiving a write-unlock-request from the calling thread, the bias-lock owner is tested. If the calling thread is the bias-lock owner, the bias-lock is identified as not having an owner-thread-read-lock and as not having an owner-thread-write-lock. If the calling thread is not the bias-lock owner, the bias-lock is identified as not having a non-owner-thread-read-lock and as not having a non-owner-thread-write-lock, and the second sub-lock is unlocked.

These and other advantages of the invention will be apparent to those of ordinary skill in the art by reference to the following detailed description and the accompanying drawings

### BRIEF DESCRIPTION OF THE DRAWINGS

FIG. 1A is a flow diagram of a lock process utilizing a compare-and-swap operation;

FIG. 1B is a flow diagram of an unlock process utilizing a compare-and-swap operation;

FIG. 1C is a flow diagram of a compare-and-swap process;

FIG. 2A is a flow diagram of a process for locking a biased-lock in accordance with an embodiment of the present invention;

FIG. 2B is a flow diagram of a process for unlocking a biased-lock in accordance with an embodiment of the present invention;

FIG. 3A is a flow diagram of a process for locking a biased-lock in accordance with an embodiment of the present invention;

FIG. 3B is a flow diagram of a process for unlocking a biased-lock in accordance with an embodiment of the present invention;

FIG. 3C is a flow diagram of a process for changing the owner of a biased-lock in accordance with an embodiment of the present invention;

FIG. 4A is a flow diagram of a process for locking a biased-lock in accordance with an embodiment of the present invention;

FIG. 4B is a flow diagram of a process for unlocking a biased-lock in accordance with an embodiment of the present invention;

FIG. 5A is a flow diagram of a process for obtaining a read lock of a biased-lock in accordance with an embodiment of the present invention;

FIG. 5B is a flow diagram of a for unlocking a read lock of a biased-lock in accordance with an embodiment of the present invention;

FIG. 5C is a flow diagram of a process for obtaining a write lock of a biased-lock in accordance with an embodiment of the present invention;

FIG. 5D is a flow diagram of a process for unlocking a write lock of a biased-lock in accordance with an embodiment of the present invention; and

FIG. 6 is a block diagram of a computing device in accordance with an embodiment of the present invention.

### DETAILED DESCRIPTION

While the discussion herein refers to threads, a person of ordinary skill in the art would understand that term thread is used in a generic sense to indicate a path of execution. While a single process may contain multiple threads, a process may also be thought of as process having a single thread (i.e., single-threaded). Accordingly, the features and processes disclosed herein are applicable to various mechanisms for concurrent execution and are described with respect to threads as a generic abstraction of such mechanisms.

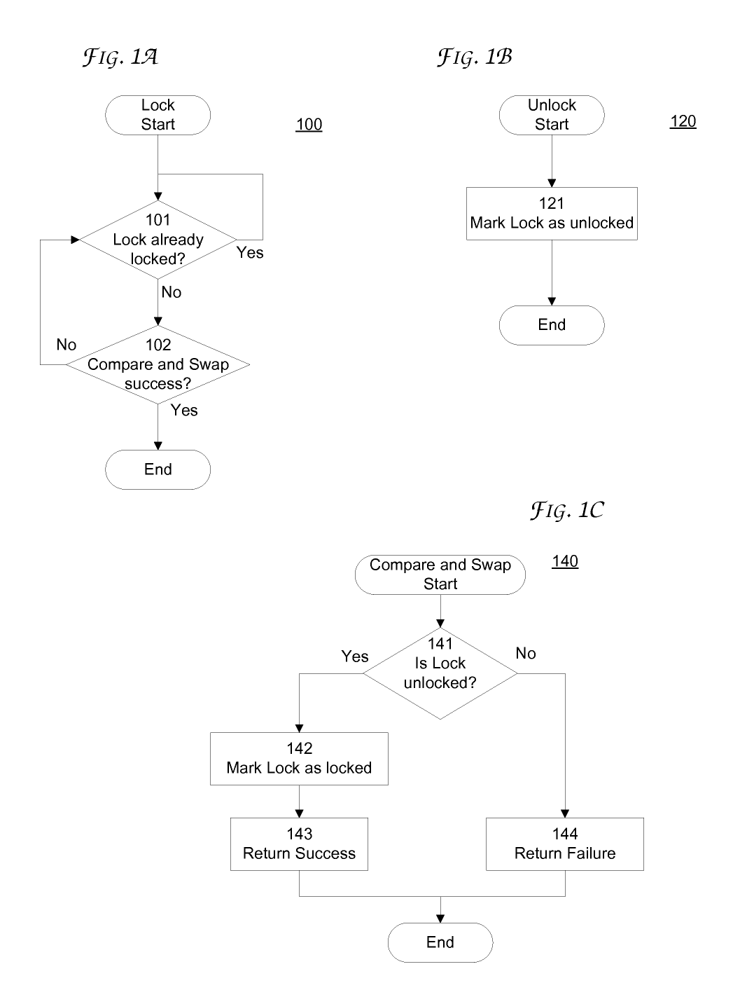

FIGS. 1A-1C illustrate processes associated with a standard implementation of a spinlock using an atomic compare-and-swap operation. Most modern computer processors have a compare-and-swap operation or an equivalent test-and-set operation. As illustrated in process 100 of FIG. 1A, to lock the spinlock a thread of execution determines at decision 101 if the spinlock is already locked. If the spinlock is locked, the thread of execution waits (i.e., spins) until the lock is unlocked. If the lock is not locked at determination 101, the thread of execution performs an atomic compare-and-swap and checks the status of the compare-and-swap operation at decision 102. Because other threads may also be attempting to acquire the lock at the same time, the change is done atomically to guarantee that only one thread changes the value. If the compare-and-swap succeeds (i.e., marks the spinlock as locked), the spinlock has been locked. Otherwise, the compare-and-swap has failed, and the thread of execution returns to decision 101 to determine if the spinlock is already locked. Although other threads would see the lock variable become 0, their compare-and-swap would fail because the winning thread would have changed the lock to 1.

FIG. 1B is a flow diagram of a process 120 for releasing a lock (i.e., unlocking) a standard implementation of a spinlock. Unlocking the spinlock merely requires the spinlock to be marked as unlocked at step 121.

Process 140 of FIG. 1C illustrates a flow diagram of the compare-and-swap operation. The compare-and-swap operation examines the spinlock and determines at decision 141 whether the lock is unlocked. If the spinlock is not unlocked, the spinlock cannot be locked and the compare-and-swap operation returns “failure” at step 144, to indicate the spinlock was not successfully locked. If the spinlock is unlocked, the spinlock is marked as locked at step 142, and the compare-and-swap operation returns “success” at step 143.

The following C programming language pseudo-code illustrates exemplary implementations of the lock and unlock functions of a standard spinlock using the illustrated exemplary atomic compare_and_swap function.

```
void lock(int _lck) {
  bool success;
  do {
    while (_lck != 0) { } /* wait */
    success = compare_and_swap(lck, 0, 1);
  }while (!success);
}
void unlock(int _lck) {_lck = 0; }
atomic /* function is one atomic machine instruction */
bool compare_and_swap(int _lck, int old, int new) {
  if (_lck == old) {
    _lck = new;
    return 1;
  }
  else
    return 0;
}
```

One mechanism for increasing the performance of locks is to optimize the lock based on a pattern access to the lock by the threads in various applications. One such pattern is found in networking applications having a single thread that dominates lock accesses (i.e., a single thread performs a great majority of the lock operations). For example, an important trivial case of this occurs when a single-threaded program calls a thread-safe library that uses locks.

An effective way to optimize this dominant-thread pattern is to “bias” the lock implementation so that access by the dominant thread has negligible overhead.

For example, if it is assumed that the dominant process (i.e., the owner of the lock) acquires the lock infinitely often (a reasonable assumption for packet processing), it is possible to make the dominant process perform a lock operation with a reduced number of fence operations (i.e., operations that enforce an ordering constraint on memory operations to ensure consistency) or compare-and-swap instructions. Moreover, in accordance with an embodiment, fence operations and atomic compare-and-swap instructions can be dispensed with entirely. These constructions can be extended for lock reservation, re-reservation, and to reader-writer situations. Additionally, the dominant process can be changed during runtime without suspending the existing owner (i.e., dominant process).

In accordance with an embodiment of the present invention, a bias-lock is created that assumes a lock is owned by a fixed, pre-specified thread (e.g., by the dominant thread). In accordance with this embodiment, different locking and unlocking processes are used for the owner of the lock and all other threads accessing the resource controlled by the lock (i.e., non-owner threads).

And exemplary data structure for such a bias-lock is illustrated in the following pseudo-code:

typedef struct {

ThreadId owner;
Lock2 t; /* lightweight, 2-process lock */
LockN n; /* N-process lock */

} Lock;

The bias-lock includes an owner as identified by the ThreadId, which can be used to uniquely identify a thread. Two locks are used by the bias-lock. The first lock is a lightweight 2-process lock (referred to below as the primary lock), which controls access to the shared resource by the owner and a single non-owner thread. The non-owner thread competing with the owner is the non-owner thread that has locked the second lock (referred to below as the secondary lock), which is an n-process lock.

Pseudo-code for a biased_lock function for locking the bias-lock and a biased_unlock function are presented below:

biased_lock(Lock _l) {

if (this_thread_id == l−>owner)

lock2(l−>t);

else {

lockN(l−>n);
lock2(l−>t);

}

}
biased_unlock(Lock _l) {

if (this_thread_id == l−>owner)

unlock2(l−>t);

else {

unlock2(l−>t);
unlockN(l−>n);

}

}

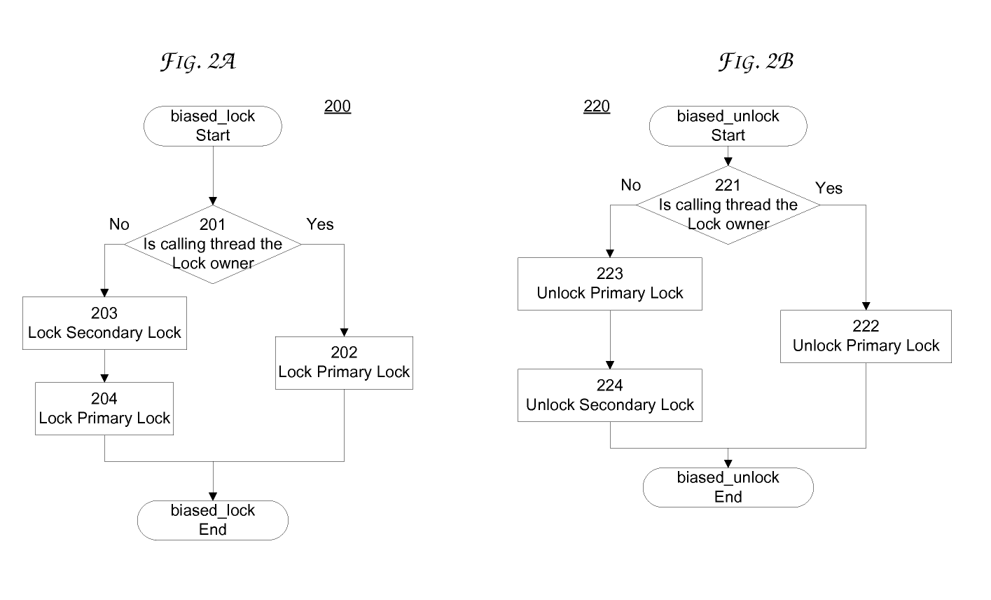

These functions are further described with respect to the flow diagrams illustrated in FIGS. 2A and 2B.

FIG. 2A is a flow diagram illustrating a biased_lock process 200. When the biased_lock process is called, it is determined at decision 201 if the calling thread is the lock owner, for example by comparing the thread ID of the calling thread to the owner Thread ID stored in the bias-lock data structure. If the calling thread is the owner of the lock, the primary lock is locked at step 202. If the calling thread is not the owner of the lock, it must first compete for the secondary n-process lock by attempting to lock the secondary lock at step 203. Once the secondary lock has been acquired, the calling thread then competes for the primary lock and attempts to lock the primary lock at step 204.

FIG. 2B is a flow diagram of a biased_unlock process 220. At decision 221, it is determined whether the calling thread is the lock owner, and if it is, the primary lock is unlocked at step 222. However, if the calling thread is not the lock owner, the primary lock is first unlocked at step 223, and the second lock is unlocked at step 224.

The techniques described in FIGS. 2A and 2B reduce the cost of access for the owning thread. Furthermore, this scheme is starvation-free if both locking protocols (i.e., the n-process lock and the 2-process lock) are individually starvation free. If only the 2-process locking protocol is starvation-free, the owner is always guaranteed to obtain the lock, but one or more of the non-owner threads could remain forever in the waiting state. Various known schemes can be used to implement the two locks. For example, Dekker's algorithm or Peterson's algorithm (illustrated in pseudo-code below) could be used to implement the 2-process lock.

flag[i] = 1;
turn = j;
fence( ); /* force other threads to see flag and turn */
while (flag[j] && turn == j) { } /* spin */
/* ...critical section... */
fence( ); /* make visible changes made in critical section */
flag[i] = 0;

The n-process lock could be implemented by the spin-lock discussed above or the Mellor-Crummey and Scott (MCS) algorithm for n-process locking. However, it should be noted that certain known algorithms, such as Peterson's algorithm, still require expensive operations to ensure memory consistency across processors, such as fence operations on the x86 computer architecture.

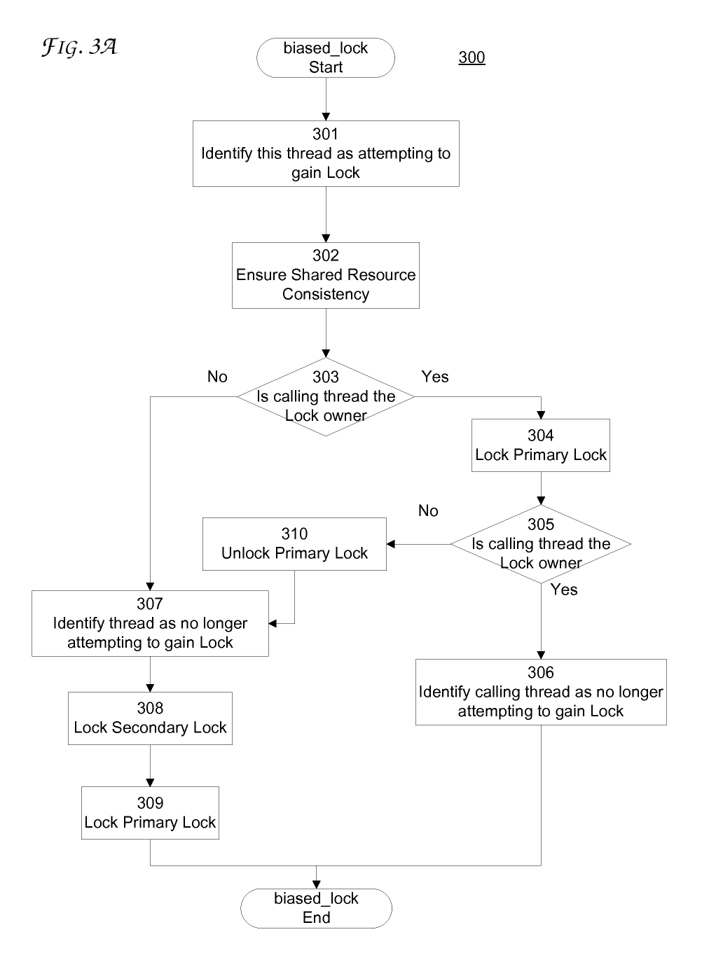

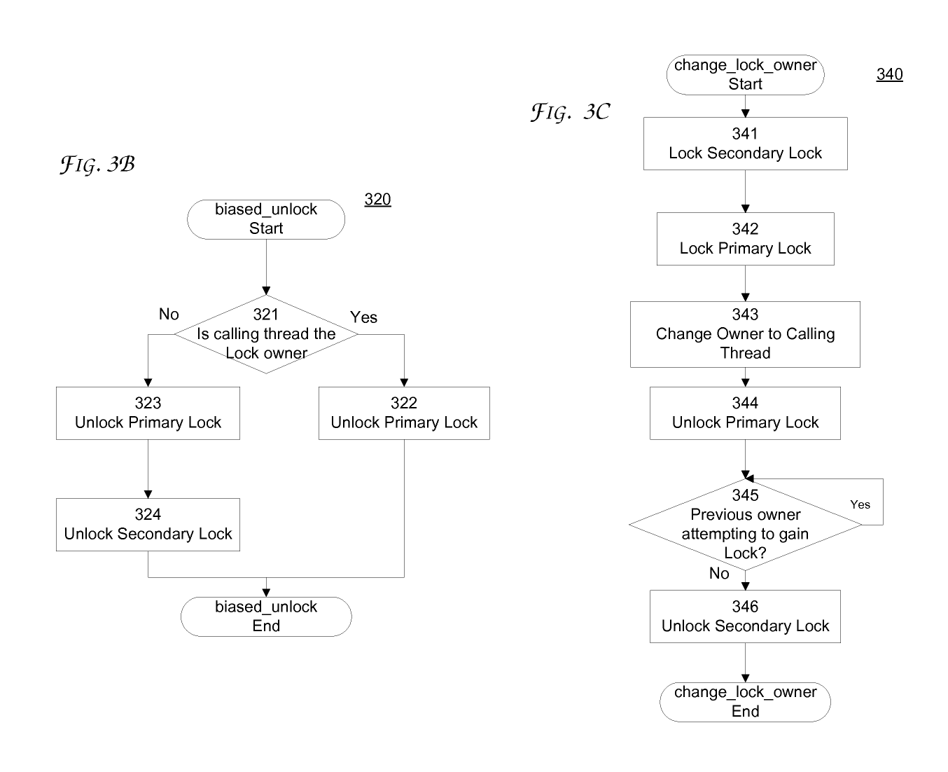

The algorithm described above with respect to FIGS. 2A and 2B utilizes a fixed owner thread that is known in advance of run-time. Changing the owner would require ensuring none of the threads have acquired, or are attempting to acquire, either the primary or secondary lock. The owner of the bias-lock could then be changed. Thus, the above algorithm can be modified to allow “on-the-fly” transfer of ownership of the bias-lock to a different thread. This algorithm is described below with respect to FIGS. 3A, 3B, and 3C.

In one implementation of on-the-fly transferable bias-locks, the bias-lock data structure is modified to track which threads are attempting to acquire the bias-lock. For example, as illustrated in the pseudo-code below, the bias-lock structure can maintain an array that is sized according to the number of threads sharing the bias-lock.

typedef struct {

ThreadId owner;
Lock2 t; /* lightweight, 2-process lock */
LockN n; /* N-process lock */
bool try[NTHREADS];

} Lock;

Each entry in the array corresponds to whether a particular thread is attempting to acquire the bias-lock. A person of ordinary skill in the art would understand that other mechanisms could be used to track which threads are attempting to acquire the bias-lock, such as a bit-vector, hash table, set, and others.

FIG. 3B is a flow diagram a biased_unlock process 320 that can be used in accordance with an embodiment of the present invention. Process 320 is identical to process 220 of FIG. 2B described above. Specifically, when the biased_unlock process is called, at decision 321, it is determined whether the calling thread is the lock owner, and if it is, the primary lock is unlocked at step 322. However, if the calling thread is not the lock owner, the primary lock is first unlocked at step 323, and the second lock is unlocked at step 324. Pseudo-code for implementation of this process is illustrated below:

void biased_unlock(Lock _l){

if (this_thread_id == l−>owner)

unlock2(l−>t);

else {

unlock2(l−>t);
unlockN(l−>n);

}

}

The following pseudo-code illustrates a biased_lock process in accordance with an embodiment of the present invention:

void biased_lock(Lock _l) {

l−>try[this_thread_id] = 1;
fence( );
if (this_thread_id == l−>owner) {

lock2(l−>t);
if (this_thread_id != l−>owner) {

/* owner has changed */
unlock2(l−>t);
goto NON_OWNER;

}
else {

/* owner has not changed */
l−>try[this_thread_id] = 0;

}

}
else {

NON_OWNER:

l−>try[this_thread_id] = 0;
lockN(l−>n);
lock2(l−>t);

}

}

The biased_lock process 300, illustrated in FIG. 3A requires modifications to the biased_lock process discussed above with respect to FIG. 2A. Specifically, when the biased_lock process 300 is called, the thread is first identified as attempting to acquire the bias-lock at step 301. As illustrated in the pseudo-code above, this identification can be performed by setting an array element associated with the calling thread of an array for tracking lock acquisition attempts to a predetermined value indicating the biased_lock process 300 has been called by the respective thread. Once the thread has been identified as attempting to acquire the lock, the consistency of the shared resource is ensured at step 302, for example by a fence operation.

At decision 303, it is determined if the calling thread is the current lock owner. If it is, at step 304, the primary lock is acquired. At decision 305 it is again determined if the calling thread is the lock owner. This verification ensures that no other thread is in the process of switching the lock owner. If the calling thread is still the lock owner, at step 306 the thread is identified as no longer attempting to acquire the bias-lock, for example by updating the array element associated with the calling thread. However, if at decision 305, it is determined the calling thread is no longer the lock owner, the primary lock is unlocked at step 310 and the calling thread is moved to the path of execution for acquiring the lock that is used by non-owner threads (i.e., steps 307, 308 and 309 discussed below).

If at decision 303, it is determined that the calling thread is not the lock owner, the thread is identified as no longer attempting to gain the lock at step 307. While the identification of step 307 could occur after the lock has been acquired (i.e., after step 308 and 309), because the thread must compete for the secondary lock (i.e., the n-process lock) before acquiring the primary lock, it is not necessary, and some efficiency or increased parallelism/concurrency may be gained by identifying the thread as no longer attempting to gain the lock as early as possible. At step 308, the secondary lock is acquired, and at step 309, the primary lock is acquired, thereby granting the bias-lock to the calling thread.

FIG. 3C illustrates a change_lock_owner process 340 that can be used to change a bias-lock owner in conjunction with the biased_lock process 300 and the biased_unlock process 320 illustrated in FIGS. 3A and 3B respectively. When a non-owner thread calls the change_lock_owner process 340, the secondary lock (i.e., n-process lock) is acquired at step 341, and at step 342, the primary lock is acquired. The owner of the bias-lock is then changed to the calling thread at step 343, for example, by updating the bias-lock date structure.

After the lock owner has been changed, the primary lock is unlocked at step 344. Before unlocking the secondary lock at step 346, the new owner of the lock must ensure that the previous owner is not attempting to acquire the bias-lock. Thus, at decision 345, it is determined if the previous owner is attempting to acquire the lock. This determination can be made, for example, by examining the array discussed above that tracks the attempts to acquire the lock. A person of ordinary skill in the art would understand that other mechanisms known in the art could be used.

The algorithm described above with respect to FIGS. 3A, 3B, and 3C guarantees correctness while permitting the owner of the bias-lock to be transferred. The algorithm addresses the scenarios when changing the owner thread is not safe, for example when the dominant thread is about to enter its critical section (i.e., access the shared resource). Therefore, a non-dominant thread is required to acquire the bias-lock (i.e., both the primary lock at step 341 and the secondary lock at step 342) before switching its status to owner at step 343. This requirement is not, however, sufficient in itself to guarantee correctness. A thread may switch to being the owner at a point in time where the earlier dominant thread is waiting for its lock. Therefore, additional synchronization is required between the old and new dominant thread, for example by checking whether the previous owner is attempting to acquire the lock at step 345.

No particular condition for switching ownership is defined by this algorithm—each application may define its own condition for when a switch is necessary. One such technique, for instance, is to maintain an average frequency of usage of a lock by each thread, and switch ownership when the frequency of a non-dominant thread exceeds that of the dominant one. This procedure adds a few instructions to the lock algorithm for the owner thread. The overhead is two additional assignments and one test, due to the infrequency of owner switching and the expected infrequency in non-owner locks.

Pseudo-code for changing the lock owner (i.e., switch_to_dominant) is presented below:

void switch_to_dominant(Lock _l) {

lockN(l−>n);
lock2(l−>t);
prev_owner = l−>owner;
l−>owner = this_thread_id;
unlock2(l−>t);
while (l−>try[prev_owner]) { }
unlockN(l−>n);

}

Given the high cost of revealing operations (i.e., operations that make updates to shared variable performed in the current thread prior to the operation visible to other processors), such as atomic and fence operations, it would be further desirable to reduce or eliminate the need for these operations in a mutual exclusion scheme. One such way to reduce the number of revealing operations is to avoid the formation of symmetric choice points (i.e., a state where two or more threads are waiting to enter a critical section and either thread can with the race). That is, reveal operations can be reduced by using an asymmetric algorithm in which the non-dominant threads (i.e., non-owner thread) request permission from the dominant thread (i.e., owner thread) to proceed.

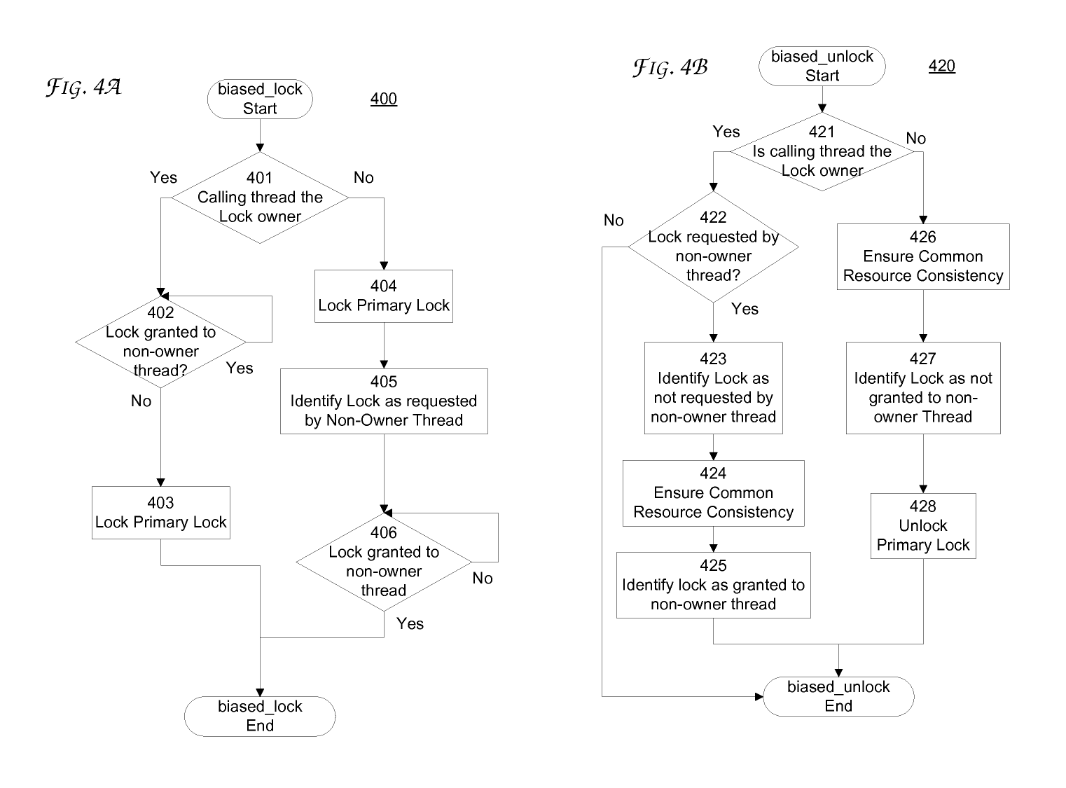

FIGS. 4A and 4B, respectively, illustrate a fixed-owner, asymmetric biased_lock process 400 and biased_unlock process 420. The asymmetric biased_lock process 400 and the asymmetric biased_unlock process 420 requires tracking or determining whether a non-owner thread has requested the bias-lock and whether a non-owner thread has been granted the bias-lock. However, because the bias-lock must be requested by a non-owner thread, the 2-process lock, which controls access by the owner-thread and the thread having the n-process lock, can be eliminated. Thus, in accordance with an embodiment of the present invention, a bias-lock can be implemented using the exemplary data-structure illustrated in the pseudo-code below:

typedef struct {

ThreadId owner;
lockN n; /* N-process lock */
bool request;
bool grant;

} Lock;

The above asymmetric bias-lock data structure uses a single n-process lock (the primary lock) and tracks whether the lock has been requested or granted to a non-owner thread using two boolean-type variables (i.e., “request” and “grant”). It is noted that in the embodiments discussed with respect to FIGS. 2A-2B and 3A-3C, the primary lock is a 2-process lock and the secondary lock is an n-process lock. However, because only one lock is required in the asymmetric lock, it is referred to herein as the primary lock.

In accordance with the fixed-owner asymmetric biased_lock process 400, at decision 401, it is determined whether the calling thread is the lock owner. If the calling thread is the lock owner, at decision 402, it is determined whether the bias-lock has been granted to a non-owner thread, for example by examining the boolean-type variable “grant” in the above data structure. If the lock has been granted to a non-owner thread, the calling thread waits (e.g., spins) until the lock is no longer granted to a non-owner thread. Once it is determined at decision 402 that the lock is not granted to a non-owner thread, the primary lock is acquired at step 403.

If the calling thread is determined not to be the owner at decision 401, the calling thread acquires the primary lock at step 404. After the primary lock has been acquired, the lock is identified at step 405 as having requested the bias-lock, for example by setting the boolean-type variable “request” discussed above. However, prior to considering the bias-lock acquired, the calling thread must wait for the owner thread to grant the bias-lock to the calling thread. Therefore, at decision 406, the calling thread determines if the owner has granted the lock, for example by examining the boolean-type “grant” variable. If the lock has not been granted, the calling thread spins (i.e., waits), but if the lock is granted, the calling thread exits process 400.

One possible implementation of the biased_lock process 400 discussed above is illustrated by the pseudo-code below:

void biased_lock(Lock _l) {

if (this_thread_id == l−>owner)

while (l−>grant) { } /* wait */

else {

lockN(l−>n);
l−>request = 1;
while (!l−>grant) { } /* wait */

}

}

In accordance with this process, a non-dominant requesting thread must wait for the dominant thread to grant it permission. This, in turn, implies that the dominant thread must periodically check the request flag. Thus, the algorithm ensures starvation-freedom for the non-dominant threads when the dominant thread checks the request flag infinitely often in any infinite computation. This can be ensured by periodically polling the request flag.

In accordance with the fixed-owner asymmetric biased_unlock process 420, at decision 421, it is determined whether the calling thread is the lock owner. If the calling thread is the lock owner, at decision 422, it is determined whether the bias-lock has been requested by a non-owner thread, for example by examining the boolean-type variable “request” in the above data structure. If the lock has not been requested, the calling thread exits the biased_unlock process 420. However, if it is determined at decision 422 that the lock was requested by a non-owner thread, at step 423, the lock is identified as not requested by a non-owner thread (i.e., the request is cleared). Consistency of the common resource is the ensured at step 424, for example through a fence operation, and the lock is identified as granted to a non-owner thread at steps 425.

If the calling thread is determined not to be the owner at decision 421, the calling thread ensures consistency of the common resource at step 426, and identifies the lock as not-granted to a non-owner thread at step 427 (e.g., clears the grant of the lock). Finally, at step 428, the primary lock is unlocked by the calling non-owner thread.

One possible implementation of the biased_unlock process 420 discussed above is illustrated by the pseudo-code below:

void biased_unlock(Lock _l) {

if (this_thread_id == l−>owner) {

if (l−>request) {

l−>request = 0;
fence( ); /* make visible all memory updates */
l−>grant = 1;

}

}
else {

fence( );
l−>grant = 0;
unlockN(l−>n);

}

}

It should be noted that in the above fixed-owner asymmetric algorithm, the dominant (i.e., owner) thread does not use a compare-and-swap instruction and uses a fence instruction only when it passes control of the critical region to a non-dominant thread. When there is no contention for the lock from non-owner threads, the dominant thread does not use any atomic or fence instructions, so locking incurs very little overhead.

A further technique for reducing the cost incurred by a locking mechanism protecting and controlling access to a shared resource is the use of non-exclusive locks (e.g., read-locks and write-locks). Any number of threads can acquire a read-lock to access the shared resource (e.g., read the memory location). However, only one thread can acquire a write-lock at any given time. Furthermore, a write-lock cannot be acquired if any other thread has acquired a read-lock, since consistency cannot be guaranteed between the data being written to the shared resource and the data being read at the same time. The biased-lock techniques discussed herein can be extended to use non-exclusive locks.

In accordance with an embodiment of the present invention, an exemplary implementation of a read-write bias-lock is illustrated by the pseudo-code below:

typedef struct {

ThreadId owner;
int flagi; /* Owner's flag */
int flagj; /* Non-owner's flag */
bool turn;
RWlockN rwn; /* N-process read-write lock */
LockN n; /* N-process lock*/
int non_owner_readers; /* No. of non-dominant readers */

}Lock;

The bias-lock is associated with an owner-thread. Additionally, the read-write bias-lock includes an n-process lock (e.g., “LockN n”), for which the non-owner threads compete, and a read-write n-process lock (e.g., “RWlockN rwn”). The RWlockN function, which obtains a normal n-process read or write lock, can use standard reader/writer locks and can be implemented to be reader starvation-free or writer starvation free. In this technique, the number of non-owner threads having a read-lock must be tracked, for example using “int non_owner_reader.” Additionally, the type of lock granted to the owner thread and the type of lock granted to a non-owner thread must be monitored. In the above data-structure, this tracking is accomplished using the flagi and flagj variables. These variables can have values corresponding to a READ, WRITE, and UNLOCK, to respectively indicate a read-lock, write-lock, or neither a read-lock or write lock.

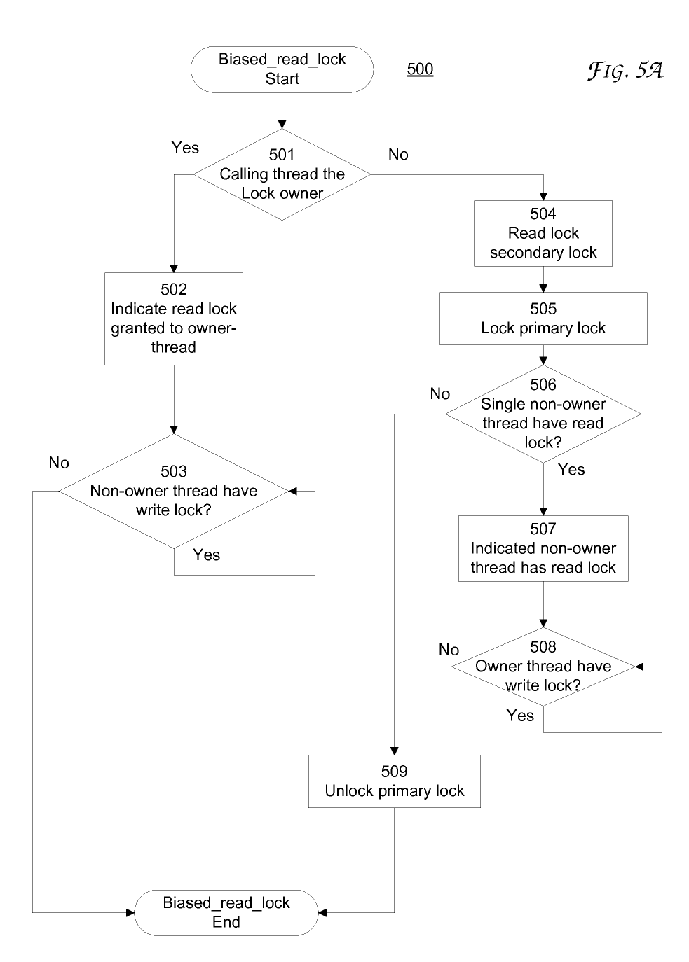

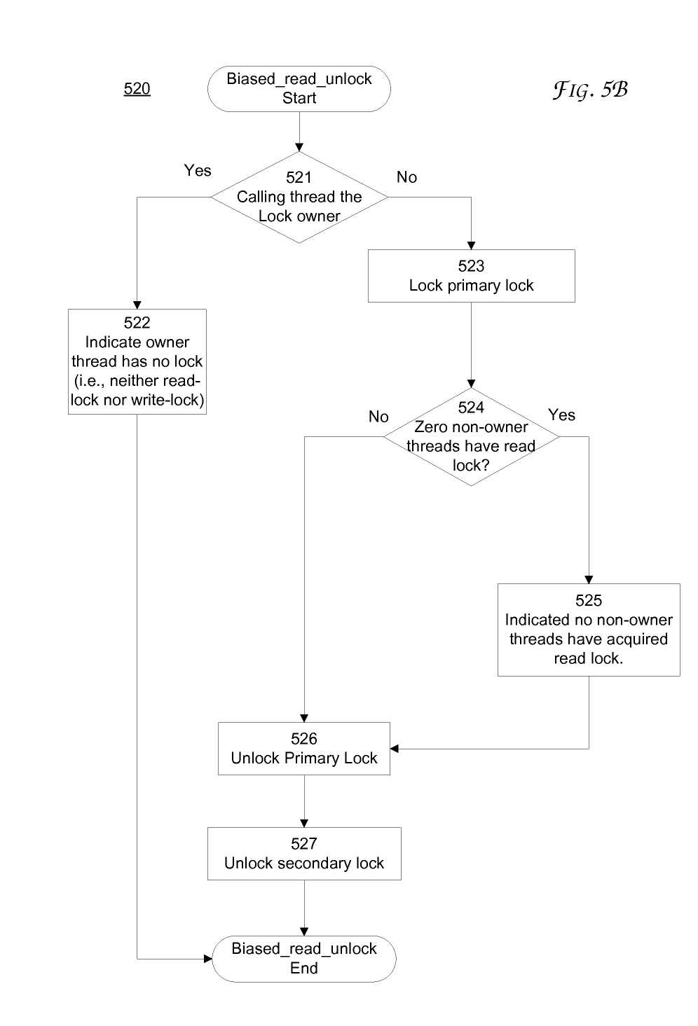

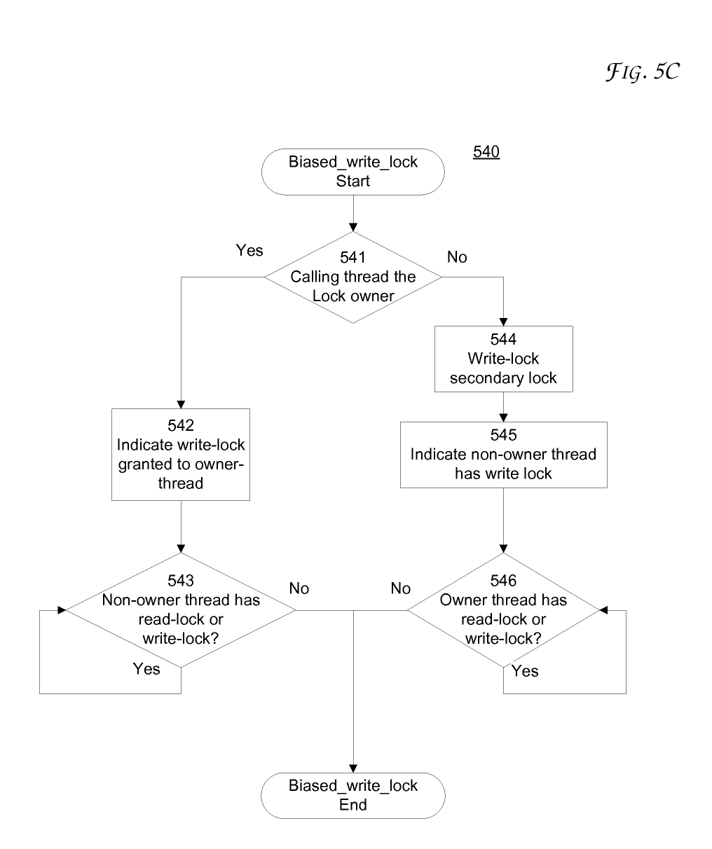

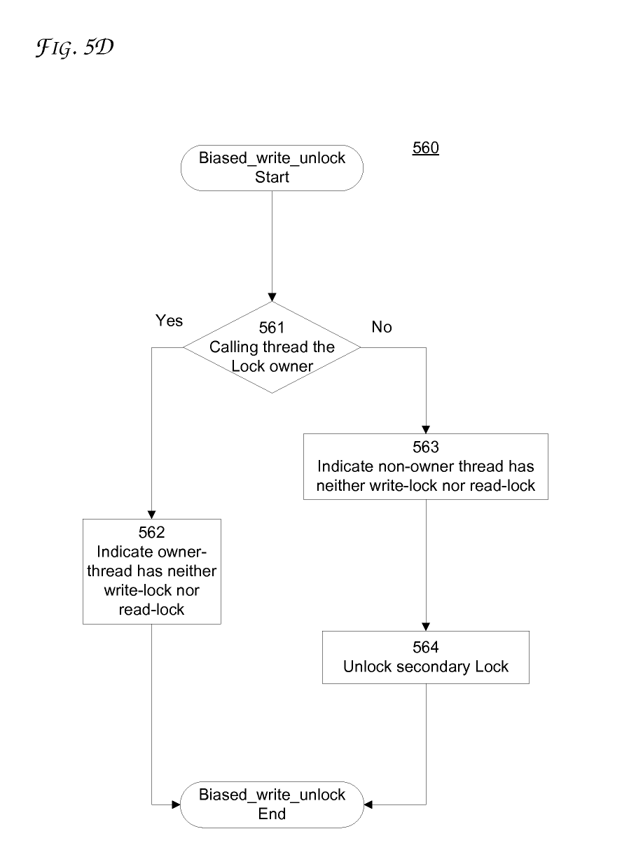

FIG. 5A is a flow diagram of a read-write bias-lock read_lock process 500 in accordance with an embodiment of the present invention. When the read_lock process 500 is called, it is first determined whether the calling thread is the lock owner, at decision 501. If the calling thread is the lock owner, the lock is marked as having been granted to the owner thread at step 502, for example by setting the flagi variable to “READ.” The calling thread then waits until it is determined at 503 that no non-owner thread has acquired a write-lock.

If at decision 501, it is determined the calling thread is not the lock owner, at step 504, a read-lock is acquired on the secondary lock (e.g., an n-process read-write lock). The primary lock is then locked at step 505. It is then determined at decision 506 whether the calling thread is the only non-owner thread having a read lock (i.e., does a single non-owner thread have a read lock?). If the calling thread is the only non-owner thread to have acquired a read-lock, the primary lock is unlocked at step 509. However, if the calling thread is not the only non-owner thread to have acquired a read-lock, it is indicated at step 507 that one or more non-owner threads have a read lock. The calling thread then waits at decision 508 until it is verified that the owner thread has not acquired a write lock. The primary lock is then unlocked at step 509.

Exemplary pseudo-code for the biased-lock read-lock function, in accordance with an embodiment of the present invention, is presented below:

void biased_r_lock(Lock _l) {

if (this_thread_id == l−>owner) {

l−>flagi = READ;
l−>turn = j;
while (l−>turn == j && l−>flagj == WRITE) { }

}
else {

rwlockN(l−>rwn, READ); /* Get a read lock */
lockN(l−>n); /* Get an exclusive lock */
l−>non_owner_readers++;
if (l−>non_owner_readers == 1) {

/* First non-dominant reader */
l−>flagj = READ;
l−>turn = i;
while (l−>turn == i && l−>flagi == WRITE) { }

}
unlockN(l−>n);

}

}

FIG. 5B is a flow diagram of a read-write bias-lock read_unlock process 520 in accordance with an embodiment of the present invention. When the read_unlock process 520 is called, it is first determined whether the calling thread is the lock owner, at decision 521. If the calling thread is the lock owner, it is indicated that the owner thread has no lock or is unlocked (i.e., neither a read-lock nor a write-lock). However, if the calling thread is determined to be a non-owner thread at decision 521, the primary lock is locked at step 523. It is then determined at decision 524 whether any other non-owner threads have acquired a read-lock. If no other non-owner thread has acquired a read-lock, an indication is made at step 525 to that effect, for example by setting the flagj variable to “UNLOCK.” The primary lock is then unlocked at step 526 and the secondary lock is unlocked at step 527.

Exemplary pseudo-code for the biased-lock read-unlock function, in accordance with an embodiment of the present invention, is presented below:

void biased_r_unlock(Lock _l) {

if (this_thread_id == l−>owner)

l−>flagi = UNLOCK;

else {

lockN(l−>n);
l−>non_owner_readers−−;
if (l−>non_owner_readers == 0)

l−>flagj = UNLOCK;

unlockN(l−>n);
rwunlockN(l−>rwn);

}

}

FIG. 5C is a flow diagram of a read-write bias-lock write_lock process 540 in accordance with an embodiment of the present invention. When the write_lock process 540 is called, it is first determined whether the calling thread is the lock owner, at decision 541. If the calling thread is the lock owner, it is indicated that the owner thread has acquired a write-lock at step 542, and at decision 543, the calling thread determines whether any non-owner threads have acquired a read-lock or a write-lock. The calling thread waits (i.e., spins) at step 542 until it is determined no lock has been acquired by any non-owner thread (e.g., the flagj variable is set to “UNLOCK”).

If the calling thread is determined to be a non-owner thread at decision 541, a write-lock is acquired on the secondary lock at step 544. It is then indicated at step 545 that a non-owner thread has acquired a write-lock. The calling thread then determines at decision 546 whether the owner thread has acquired a read-lock or a write-lock. The calling thread waits (e.g., spins) at step 546 until it is determined no lock has been acquired by the owner thread (e.g., the flagi variable is set to “UNLOCK”).

Exemplary pseudo-code for the biased-lock write-lock function, in accordance with an embodiment of the present invention, is presented below:

void biased_w_lock(Lock _l) {

if (this_thread_id == owner) {

l−>flagi = WRITE;
l−>turn = j;
while (l−>turn == j && l−>flagj != UNLOCK) { }

}
else {

rwlockN(l−>rwn, WRITE);
l−>flagj = WRITE;
l−>turn = i;
while (l−>turn == i && l−>flagi != UNLOCK) { }

}

}

As shown, for the dominant thread (i.e., owner thread) to obtain either a read lock (process 500) or write lock (process 540), when there is no contention, the owner thread only needs to set the required flags and compare required flags. It, therefore, has far less overhead than standard n-process read-write locks.

FIG. 5D is a flow diagram of a read-write bias-lock write_unlock process 560 in accordance with an embodiment of the present invention. When the write_unlock process 560 is called, it is first determined whether the calling thread is the lock owner, at decision 561. If the calling thread is the lock owner, it is indicated that the owner thread has acquired neither a read-lock nor a write-lock at step 562

If the calling thread is determined to be a non-owner thread at decision 561, it is then indicated at step 563 that no non-owner thread has acquired a write-lock or a read-lock (e.g., the flagj variable is set to “UNLOCK”). The secondary lock is then unlocked at step 564.

Exemplary pseudo-code for the biased-lock write-unlock function, in accordance with an embodiment of the present invention, is presented below:

void biased_w_unlock(Lock _l) {

if (this_thread_id == l−>owner)

l−>flagi = UNLOCK;

else {

l−>flagj = UNLOCK;
l−>rwunlockN(l−>rwn);

}

}

It should be noted that in the read-write bias-lock algorithm, between the dominant and non-dominant process, a dominant writer process may starve, especially when non-dominant reader processes continually request the lock and never relinquish the lock. However, because these readers are non-dominant, the readers are expected to arrive infrequently and therefore starvation is unlikely in practice.

Experimental evaluation shows that, in practice, the above algorithms perform well when the dominance fraction is high. Thus, for certain applications, e.g., network packet processing, overhead and incurred cost of locking mechanisms can be reduced.

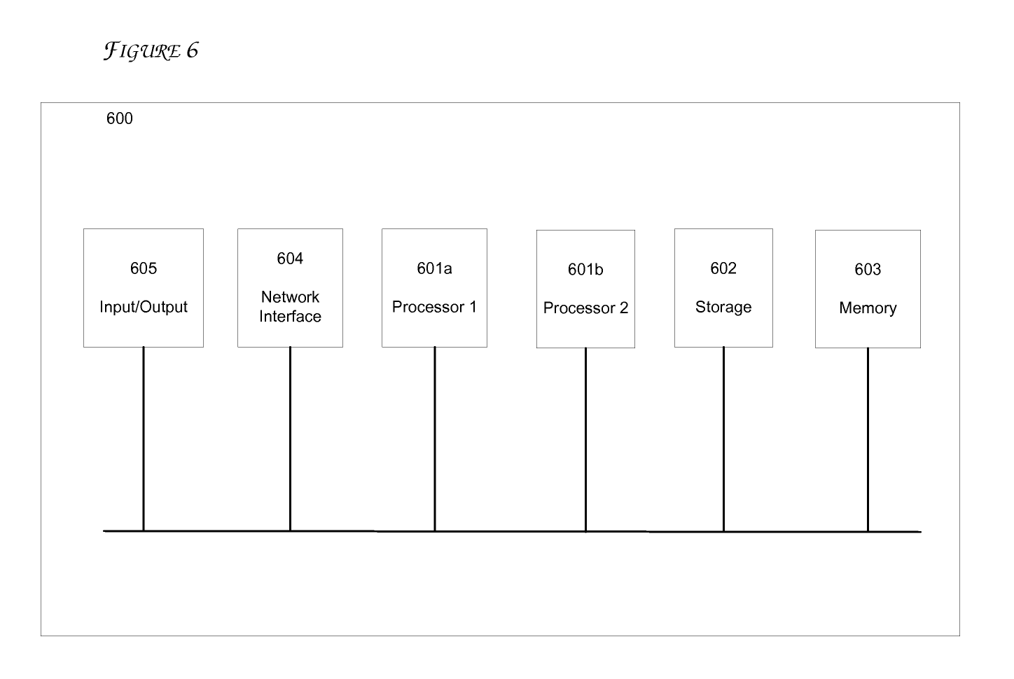

The above-described methods for controlling access to shared resources can be implemented on a computer using well-known computer processors, memory units, storage devices, computer software, and other components. A high-level block diagram of such a computer is illustrated in FIG. 6. Computer 600 contains a first processor 601a and a second processor 601b, which controls the overall operation of the computer 600 by executing computer program instructions that define such operations. While illustrated as including two processors, a person of ordinary skill in the art would understand t the above-described methods could be implemented by a computer 600 with a single processor, two processors, or more than two processors. Additionally, each processor of compute 600 could be a multi-core processors. The computer program instructions may be stored in a storage device 602, or other computer readable medium (e.g., magnetic disk, CD ROM, etc.), and loaded into memory 603 when execution of the computer program instructions is desired. Thus, the method steps of FIGS. 1A-1C, 2A-2B, 3A-3C, 4A-4B, and 5A-5D and the pseudo-code presented above can be defined by the computer program instructions stored in the memory 603 and/or storage 602 and controlled by the processors 601a and 601b executing the computer program instructions. For example, the computer program instructions can be implemented as computer executable code programmed by one skilled in the art to perform an algorithm defined by the method steps of FIGS. 1A-1C, 2A-2B, 3A-3C, 4A-4B, and 5A-5D and the pseudo-code presented above. Accordingly, by executing the computer program instructions, the processors 601a and 601b execute an algorithm defined by the method steps of FIGS. 1A-1C, 2A-2B, 3A-3C, 4A-4B, and 5A-5D and the pseudo-code presented above. The computer 600 also includes one or more network interfaces 604 for communicating with other devices via a network. The computer 600 also includes input/output devices 605 that enable user interaction with the computer 600 (e.g., display, keyboard, mouse, speakers, buttons, etc.). One skilled in the art will recognize that an implementation of an actual computer could contain other components as well, and that FIG. 6 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention. The various functional modules that are shown are for illustrative purposes only, and may be combined, rearranged and/or otherwise modified.

We claim:

1. A method for controlling access by a plurality of threads to a common resource using a bias-lock having a single owner selected from among the plurality of threads, a first sub-lock, and a second sub-lock, the method comprising:
in response to receiving a request to lock the bias-lock from a first thread:
testing the bias-lock owner;
in response to determining the first thread is the bias-lock owner, locking the first sub-lock; and
in response to determining the first thread is not the bias-lock owner, locking the second sub-lock and
locking the first sub-lock after successfully locking the second sub-lock.

2. The method of claim 1, further comprising:
in response to receiving a request to unlock the bias-lock from the first thread:
testing the bias-lock owner;
in response to determining the first thread is the bias-lock owner, unlocking the first sub-lock; and
in response to a determining the first thread is not the bias-lock owner unlocking the first sub-lock and
unlocking the second sub-lock the after successfully unlocking the first sub-lock.

3. The method of claim 1, further comprising:
in response to receiving a request from a second thread to associate the second thread as the bias-lock owner:
locking the second sub-lock;
locking the first sub-lock after successfully locking the second sub-lock;
changing the bias-lock owner to the second thread;
unlocking the first sub-lock;
ensuring a previous lock owner is not requesting to lock the bias-lock, the previous owner being the bias-lock owner prior to unlocking the first sub-lock; and
unlocking the second sub-lock.

4. The method of claim 3, wherein in response to receiving a request to lock the bias-lock and the first thread is the bias-lock owner, the method further comprising:
re-testing the ownership of the bias-lock after successfully locking the first sub-lock; and
in response to re-testing the ownership of the bias-lock determining the first thread is not the bias-lock owner,
unlocking the first sub-lock,
locking the second sub-lock, and
locking the first sub-lock after successfully locking the second sub-lock.

5. The method of claim 4, further comprising ensuring consistency of the common resource for at least the plurality of threads in response to receiving a request to lock the bias-lock and prior to testing the ownership of the bias-lock.

6. A method for controlling access by a plurality of threads to a common resource using a bias-lock having a sub-lock and a single owner selected from among the plurality of threads, the method comprising,
in response to receiving a request to lock the bias-lock from a first thread:
testing the bias-lock owner;
in response to determining the first thread is the bias-lock owner,
ensuring the bias-lock is not granted to a non-owner thread, the non-owner thread being another of the plurality of threads; and
in response to determining the first thread is not the bias-lock owner, the first thread being the non-owner thread,
locking the sub-lock,
identifying the bias-lock as requested by the non-owner-thread, and
ensuring the bias-lock owner has granted the bias-lock to the non-owner thread.

7. The method of claim 6, further comprising:
in response to receiving a request to unlock the bias-lock from a first thread:
testing the bias-lock owner;
in response to determining the first thread is the bias-lock owner
testing whether the bias-lock is identified as requested by the non-owner-thread and,
in response to determining the bias-lock is identified as requested
by the non-owner-thread,
removing the identification of the bias-lock as requested by the non-owner-thread identification of the bias-lock as requested by the non-owner thread,
ensuring consistency of the common resource for at least the plurality of threads, and
identifying the bias-lock as locked by the non-owner thread; and
in response to determining the first thread is not the bias-lock owner,
ensuring consistency of the common resource for at least the plurality of threads,
removing the identification of the bias-lock as locked by the non-owner thread, and
unlocking the sub-lock.

8. A method for controlling access by a plurality of threads to a common resource using a bias-lock configured to provide a read-lock and a write-lock and having a single owner selected from among the plurality of threads, a first sub-lock, and a second sub-lock, the method comprising,
in response to receiving a read-lock request from a first thread:
testing the bias-lock owner;
in response to determining the first thread is the bias-lock owner,
identifying the bias-lock as locked for reading by the owner and ensuring a non-owner thread has not acquired the write-lock of the bias-lock; and
in response to determining the first thread is not the bias-lock owner,
obtaining a read-lock of the second sub-lock,
locking the first sub-lock,
testing for a number of threads having the read-lock of the bias-lock,
in response to determining one non-owner thread has the read-lock of the bias-lock,
identifying the bias-lock as having a non-owner-thread-read-lock and
ensuring the owner has not obtained an owner-thread-write-lock, and
unlocking the first sub-lock.

9. The method of claim 8, further comprising:
in response to receiving a write-lock request from the first thread:
testing the bias-lock owner;
in response to determining the first thread is the bias-lock owner,
identifying the bias-lock as having the owner-thread-write-lock and
ensuring the bias-lock is not identified as having the non-owner-thread-write-lock and is not identified as having the non-owner-thread-read-lock; and
in response to determining the first thread is not the bias-lock owner,
obtaining a write-lock of the second sub-lock,
identifying the bias-lock as having the non-owner-thread-write-lock and
ensuring the bias-lock is not identified as having the owner-thread-write-lock and is not identified as having the owner-thread-read-lock.

10. The method of claim 8 further comprising:
in response to receiving a read-unlock-request from the first thread:
testing the bias-lock owner;
in response to determining the first thread is the bias-lock owner,
identifying the bias-lock as not having an owner-thread-read-lock and not having an owner-thread-write-lock; and
in response to determining the first thread is not the bias-lock owner,
locking the first sub-lock,
in response to determining no non-owner-thread have requested a
read-lock of the bias-lock,
identifying the bias-lock as not having a non-owner-thread-read-lock and as not having an non-owner-thread-write-lock,
unlocking the first sub-lock, and
unlocking the second sub-lock.

11. The method of claim 8, further comprising:
in response to receiving a write-unlock-request from the first thread:
testing the bias-lock owner;
in response to determining the first thread is the bias-lock owner,
identifying the bias-lock as not having an owner-thread-read-lock and as not having an owner-thread-write-lock; and
in response to determining the first thread is not the bias-lock owner,
identifying the bias-lock as not having an non-owner-thread-read-lock and as not having an non-owner-thread-write-lock and unlocking the second sub-lock.
